(19) United States
(12) Patent Application Publication
(10) Pub. No.: US 2025/0233139 A1
(43) Pub. Date: Jul. 17, 2025

(54) Electrical Generation System Using an Aluminum-Water Cell

(71) Applicant: Clean Water Ventures, Inc., Reno, NV (US)

(72) Inventors: Roy H. DiBenerdini, Barrington, RI (US); Anthony J. Sansone, Reno, NV (US); John Hughes, Ledgewood, NJ (US); Lauren Sammes, Reno, NV (US)

(21) Appl. No.: 18/732,433

(22) Filed: Jun. 3, 2024

Related U.S. Application Data
(60) Provisional application No. 63/620,059, filed on Jan. 11, 2024.

(51) Int. Cl. H01M 4/46; H01M 4/02; H01M 4/583; H01M 6/04; H01M 50/431

(52) U.S. Cl. CPC H01M 4/463; H01M 4/583; H01M 6/045; H01M 50/431; H01M 2004/027; H01M 2004/028

(57) ABSTRACT

An electric generation system (EGS) in which aluminum is an anode material in an electrochemical Al-water cell. The aluminum anode is controllably moved in the electrolyte in such a way to modulate and control the electrical energy output from the cell. The Al-water cell includes an electrolyte solution in a tank, the movable anode, a cathode that reduces water to hydrogen gas and hydroxide ions, and a membrane situated between the anode and cathode allowing passage of hydroxide ions. An electrical monitoring system monitors the electrical output from the cell and a power controller controllably moves the anode to control electrolyte exposure and provide a desired electrical output from the cell, responsive to the anode position and monitored electrical output. A plurality of Al-water cells can be configured in combinations such as series and/or parallel connections, to realize a large-scale EGS.

### CROSS-REFERENCE TO RELATED APPLICATIONS

The present application claims priority to the following patent applications, assigned to the assignee of the present invention, the contents of which are incorporated by reference herein: U.S. Provisional Patent Application Ser. No. 63/620,059, filed Jan. 11, 2024, entitled “ELECTRICAL GENERATION SYSTEM USING AN ALUMINUM-WATER CELL”

### BACKGROUND

### (1) Technical Field

The present invention relates to battery and fuel cell technology, and particularly to electrical power generation systems that use aluminum-water cells to produce electrical energy and provide a controlled electrical output.

### (2) Background

Aluminum-based battery technologies have been widely regarded as one of the most promising options to drastically improve, and possibly replace, existing battery systems. This is mainly due to the possibility of achieving very high energy density with low cost.

One type of aluminum (Al)-based battery being developed is an aluminum-air battery. We know from published literature that an aluminum-air battery includes an aluminum-metal negative electrode, a positive electrode enabling oxygen transport and reduction, and a suitable electrolyte. The electrolyte is typically an alkaline solution consisting of sodium hydroxide (NaOH), potassium hydroxide (KOH), or sodium chloride (NaCl). The aluminum air battery is typically a primary cell (i.e. non-rechargeable) because the cell ingredients are consumed and therefore the battery cannot be recharged.

FIG. 1 is a diagram that shows one example of the components of an aluminum-air battery, and illustrates its operation. In the aluminum-air battery 100, an aluminum metal plate 110 operates as an anode that is completely reacted to produce aluminum hydroxide [Al (OH) 3] in an electrolyte solution. Oxygen (O₂) from the air is reduced at an air cathode 120 to produce hydroxide ions (OH⁻) that are supplied to the anode. The air cathode 120 is made of a porous material to allow air (oxygen) to flow into the anode. In a typical aluminum-air battery:
□ The anode oxidation half-reaction is Al+3OH⁻→Al(OH)₃+3e (−2.31V).
□ The cathode reduction half-reaction is O₂+2H₂O (KOH solution)+4e-→40H (+0.4V).
□ The balanced equation is 4Al+3O₂+6H₂O→4Al(OH)₃. (+2.71V)

Aluminum electrodes are used extensively in electrocoagulation, which is a technique for treating contaminated water such as wastewater, wash water, and industrially processed water. Electrocoagulation can remove contaminants that are generally more difficult to remove by filtration or chemical treatment systems. The electrocoagulation process generates excess heat from the electrocoagulation reaction with aluminum, and this excess heat can be converted to electrical energy, e.g., using a turbine. Although this conversion process does utilize the excess heat, the conversion process is inefficient and can be costly, requiring a significant initial investment in machinery, and incurring continuing operating costs and maintenance expenses.

It would be an advantage to convert the electrochemical energy from an aluminum battery directly to electrical energy. The present invention addresses this challenge.

### SUMMARY

An aluminum-water electric generation system (EGS) is described in which aluminum (e.g., pure aluminum, scrap aluminum or an alloy) is used as an anode material in an Al-water cell. The aluminum anode is controllably moved in the electrolyte (e.g., KOH, NaOH), in such a way to modulate and control the electrical energy output from the aluminum-water cell. An electrical monitoring system monitors the electrical output from the cell, and a power controller controllably moves the anode to control electrolyte exposure and provide a desired electrical output from the cell, responsive to the anode position and monitored electrical output.

The aluminum-water cell includes a water-reducing cathode, which may be constructed of an inert graphite-based material. Water is fed to the cathode, together with electrons from the anode, and a chemical reaction splits the water into hydroxide (OH—) ions and hydrogen (H₂) gas. The hydroxide ions migrate through the cell's electrolyte to the anode, where they react with Al ions.

At the anode, the resulting reaction yields aluminum tetrahydroxide ions [Al(OH)₄—] and three electrons (3c⁻). The electrochemical reaction with aluminum in the cell improves if it is done in a basic solution that supplies more excess OH⁻ ions. The three electrons may return to the cell's cathode via an electrical connection. An electrical load may be also connected, thereby supplying the load with power.

By feeding aluminum to an electrolyte bath (such as KOH) in the cell, and having that aluminum feed electrically connected (as an anode) to a cathode material, such as activated charcoal (and using a catalyst such as Ni, for example), an electrochemical reaction occurs in which the aluminum oxidizes to aluminum ions. Eventually, the aluminum ions will combine with hydroxide (OH⁻) to form aluminum hydroxide, which will settle. The electrons from the aluminum ions flow from the anode to the cathode via an external circuit. At the cathode, the electrons (current) facilitate reduction of the incoming water (which is fed into the cathode side), forming OH⁻ ions and hydrogen. This process will continue as long as aluminum is available at the anode.

The electrons flow from the anode to the cathode via an external circuit. The electrons then flow back to the anode via the transport of the OH-ion, thus producing a current (i.e., generating electrical power). The electrical power that is output is equivalent to the Gibbs free energy produced by the exothermic chemical reaction via the chemical oxidation of aluminum to aluminum hydroxide. Thus, predominantly electrical energy is generated in the aluminum water cell, as well as the equivalent stoichiometric amount of aluminum hydroxide and hydrogen. Although some thermal energy may also be produced in the cell, the thermal energy is produced in lesser amounts than the electrical energy.

The Electric Generation System (EGS) includes an electrical monitoring system that monitors the electrical output from the cell the monitoring system connected to an electrical connection between the anode and cathode. A power controller controllably moves the anode to control electrolyte exposure and provide a desired electrical output from the cell, responsive to the anode position and monitored electrical output. In some embodiments an anode monitoring system is connected to the power controller to monitor the position of the anode in the Al-water cell, and an anode driver is connected to the power controller and the anode, to move the anode within the electrolyte and modulate the electrical output from the cell. The anode monitoring system may include a position sensor that measures the position of the anode, and a displacement sensor that measures the displacement of the anode. In some embodiments the power controller controls the Al-water cell to generate an electrical output that includes alternating current, such as approximately 60 Hz, 120 Volts. The power controller may receive waveform requirement parameters and modulate the anode responsive to the waveform requirements to provide a wide range of possible electrical outputs.

In some embodiments, the EGS may include a plurality of Al-water cells configured in combinations such as series and/or parallel connections. In some such embodiments, a large-scale system (from kW to MW output) can be realized. As a further advantage, hydrogen (which has additional energy content) is produced in each Al-water cell as a by-product.

The details of one or more embodiments of the invention are set forth in the accompanying drawings and the description below. Other features, objects, and advantages of the invention should be apparent from the description and drawings, and from the claims.

### BRIEF DESCRIPTION OF THE DRAWINGS

FIG. 1 is a diagram that shows one example of the components of a prior art aluminum-air battery, and illustrates its operation.

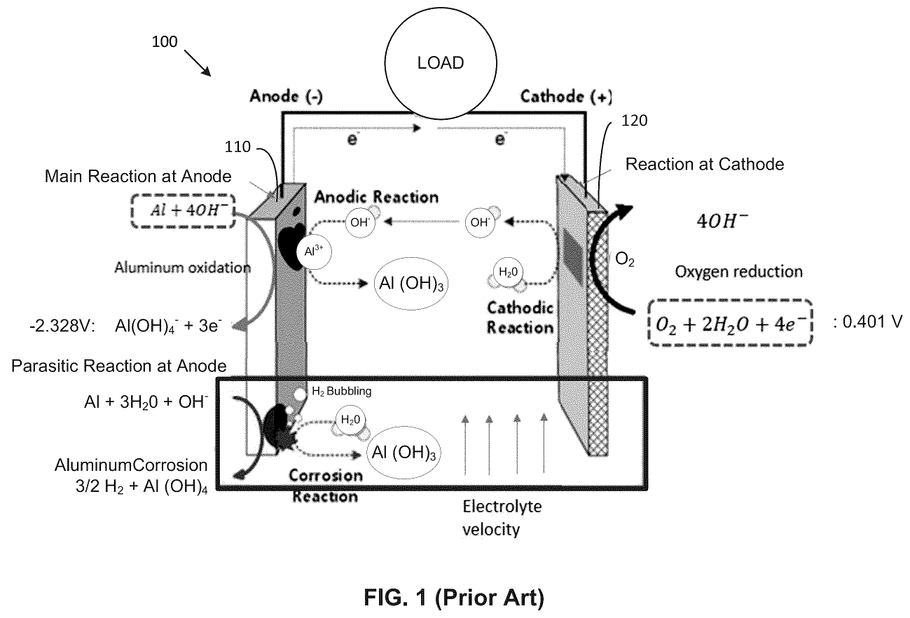

FIG. 2 is a cross-sectional view of one embodiment of an Al-water cell.

FIG. 3 is a cross-sectional diagram of an operating Al-water cell.

FIG. 4 is a flowchart that shows steps for generating electrical energy and managing cell operations in an Electric Generation System (EGS).

FIG. 5 is a block diagram of one embodiment of an EGS for generating electrical power using one or more electrochemical cells.

FIG. 6 is a schematic block diagram of one embodiment of an EGS.

FIG. 7 is a schematic block diagrams of an alternative embodiment of an EGS that has multiple anodes in a single cell.

FIG. 8 is a schematic block diagrams of an alternative embodiment of an EGS that includes multiple cells.

Like reference numbers and designations in the various drawings indicate like elements.

### DETAILED DESCRIPTION

### (1) Overview of the Aluminum-Water EGS

As described herein, an Electric Generation System (EGS) includes an Al-water cell with a movable anode and a Power Controller connected to the cell. The Power Controller monitors the electrical output and moves the anode to provide the desired electrical power waveform. In the following description, an aluminum-water (Al-water) cell will be described first, and then an EGS will be described that includes the Al-water cell. Alternative embodiments will be described in which multiple cells are electrically connected in series and/or in parallel, and controlled together, which can provide more power and higher voltages.

### (2) Al-Water Cell Description

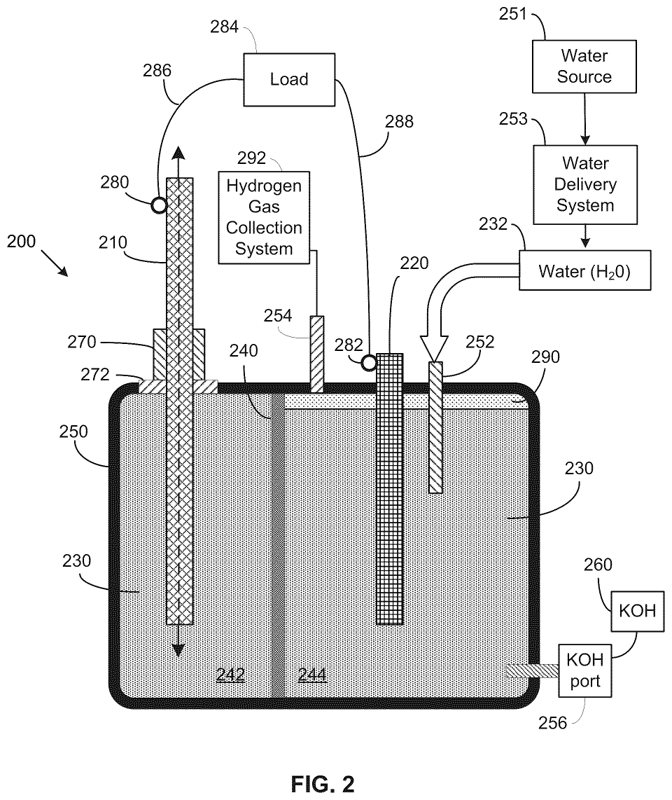

FIG. 2 is a cross-sectional view of one embodiment of an Al-water cell 200. The following is a description of components in the Al-water cell 200 shown in FIG. 2, and some examples of those components.

A functioning aluminum-water (Al-water) cell 200 can be realized by placing an anode 210 made of aluminum and a cathode 220 made from an appropriate water-reducing material into a suitable electrolyte (e.g., KOH) solution 230, and supplying water 232 to the cathode 220. The anode 210 and cathode 220 are separated in the KOH solution 230 by a hydroxide ion (OH⁻) conducting membrane 240. Further details are provided below.

### Tank

A tank 250 is provided to contain the electrolyte 230. The tank 250 is made of a suitable material, such as a high-grade stainless steel, that is resistant to corrosion and appropriate to contain electrolytes. The tank 250 defines a plurality of openings, including an anode opening to insert one or more anode(s), a cathode opening for the cathode 220, and other openings to accommodate various ports and sensors. The tank ports may include a water port 252 to insert water, a gas port 254 to allow hydrogen gas to flow from the tank, and an electrolyte port 256 to insert electrolyte.

The tank 250 is made to an appropriate shape, size and configuration to allow production of the desired amount of energy. For example, when used for commercial production, the tank may hold an approximate volume of between 250 and 500 liters.

### Electrolyte

A suitable aqueous electrolyte solution 230 is provided to the tank. In some embodiments, Potassium Hydroxide (KOH) 260 is the main electrolyte in the solution. In some embodiments, KOH is substantially the only electrolyte; in other embodiments, NaOH or other electrolytes may be used, alone or in combination. To replenish the concentration of electrolyte during operation, the electrolyte feed port 256 is provided to add electrolyte as needed.

### Membrane

The anode 210 and cathode 220 are separated in the KOH solution 230 by a hydroxide ion (OH⁻) conducting membrane 240; particularly, the membrane 240 is situated in the tank, immersed in the electrolyte solution 230 between the anode 210 and the cathode 220. The membrane 240 physically separates the tank into an anode side 242 and a cathode side 244. The membrane 240 is configured to pass the OH-generated at the cathode through to the anode. The membrane type and configuration are selected to provide desired performance to the particular cell's design.

In one example, the membrane 240 is a solid oxide membrane, such as that available from Bloom Energy of San Jose, CA. In another example, the membrane is a proton conducting membrane such as disclosed in US Patent Application 2018/0363150, published Dec. 20, 2018, entitled “Electrochemical Production of Water Using Mixed Ionically and Electronically Conductive Membranes”. Design considerations determine the choice of membrane: for example, a solid oxide membrane can provide more efficient operation, but the proton conducting membrane can perform better at higher temperatures.

### Cathode

The cathode 220 is made of a material, such as extruded graphite, that can reduce the water to H₂ and OH. The cathode can have any suitable shape; for example, it may be a continuous piece, an extruded member, or any configuration, such as a rod or bar. Although the cathode could have any shape, for many uses, a rod configuration is useful and preferred.

### Water Supply to Cathode

The water inlet 252, such as a tube placed into an opening in the tank 250, is used to deliver water into and around the cathode. The water inlet 252 is sealed within its opening in the tank in order to prevent leakage.

A suitable water source 251 and a controllable delivery system 253 (such as a pump and hose) are used to deliver the needed water to the cathode 220; i.e., to supply water for reduction at the cathode 220. Preferably, the water supplied to the cathode 220 is substantially “clean” water (such as distilled water) free of contaminants that could otherwise interfere with the reactions in the cell. The water level and pressure in the tank 250 can be monitored to provide the appropriate water flow and pressure for the desired reduction rate and power output.

### Anode

The anode 210 is made of aluminum or alloys of aluminum. For example, recycled aluminum can be used. The anode 210 can have any suitable shape, for example aluminum rods can be used, which advantageously can have lower costs than other forms and shapes, such as aluminum ingots. The anode 210 is slidable in and out of the tank 250, to control the surface area of the anode that is in contact with the electrolyte solution 230.

A slidable sleeve 270 and a flexible seal 272 are provided for the anode 210. The sleeve 270 can be, for example, a metal or plastic bushing that has a suitable shape for the anode 210. In one example, the anode has the shape of a rod bearing a circular cross section, and therefore the sleeve 270 will have a corresponding circular hole to allow axial movement of the rod. To prevent leakage of electrolyte (i.e., maintain a seal) while the anode rods are being moved, the flexible seal 272 adapts to the changing shape of the anode. The seal allows the rod to slide through it when newly inserted, and yet has enough flexibility to seal the opening after the rod has become deeply pitted and deformed due to oxidation. Typically, the reaction on the anode side is not under pressure, and the sleeve/seal design can take that into account. The slidable sleeve and flexile seal can be one unit, or two components or more, as appropriate.

As will be described in more detail, the anode 210 can move in and out to feed and control the amount of aluminum anode material in the electrolyte solution, and therefore control the electrical output.

### Electrical Connection

To provide a functioning electrochemical cell, the anode 210 and cathode 220 must be electrically connected, usually with some type of load 284 in-between. The load 284 can be anything that consumes, stores, or otherwise uses electrical energy: e.g., a motor, power grid, battery storage, or other load.

To provide electrical connections, the anode 210 may have an anode terminal 280, and the cathode 220 may have a cathode terminal 282. The load 284 is electrically connected to each of the terminals 280, 282 by any suitable electrical connection, for example, the load 284 is connected to a wire 286 that is also connected to the anode terminal 280, and the load 284 is connected to a wire 288 that is also connected to the cathode terminal 282.

### Hydrogen Gas Collection

The hydrogen gas 290 that is generated at the cathode 220 by operation of the cell, collects in the tank 250 above the electrolyte solution 230 on the cathode side 244, and from there is directed out of the tank 250 to a hydrogen gas collection system 292. The gas outlet port 254, outputs hydrogen gas 290 directly from the tank. The gas outlet port 254 has any suitable configuration; in some embodiments, this may be a tube in an opening in the tank. The port may also have a valve and include a pressure sensor and gauge. In some embodiments, the valve is an on-off valve that opens manually or opens automatically at a particular pressure. In other embodiments, the valve may variably control flow and/or pressure.

The hydrogen gas 290 from the outlet port 254 is provided to the hydrogen gas collection system 292. For example, the collection system may include a delivery system to direct the hydrogen gas 290 to a suitable location such as a pressurized gas tank. From there, the hydrogen gas 290 can be delivered to a remote location, such as a hydrogen storage facility or to an infrastructure from which it can be distributed. The hydrogen gas 290 can then be supplied to fuel cars, trucks, buses, or anywhere it may be useful.

### (3) Cell Energy Production

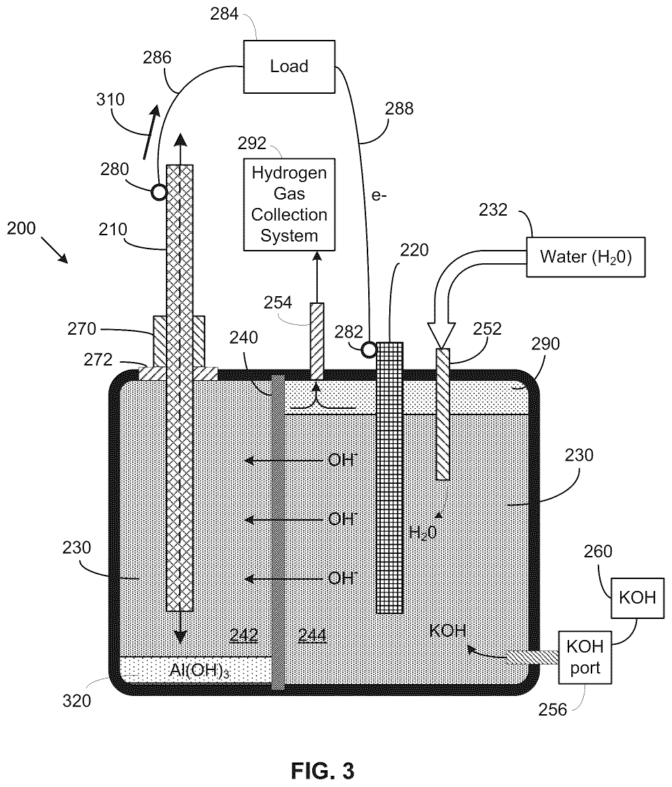

FIG. 3 is a cross-sectional diagram of an operating Al-water cell. The Al-water cell 250 produces hydrogen 290 and electricity 310 in an electrochemical process. To produce hydrogen gas 290, water 232 is reduced to hydroxide (OH⁻) ions and hydrogen (H₂) gas on the cathode side 244 of the cell. The resultant hydrogen gas 290 rises to the top of the cathode side 244 of the tank 250, displacing the electrolyte solution 230, and passes out through the hydrogen gas outlet 254 to the hydrogen gas collection system 292.

To produce electricity 310, the hydroxide ions (OH⁻) travel through the membrane 240 to the anode side 242 where they react with the aluminum anode 210 to yield an aluminum tetrahydroxide ion Al(OH)₄ and three electrons. The process creates a voltage potential of 1.47v and a current 310 that is related to (a function of) the surface area of the anode 210 and the rate of the reaction. Thus, the rate of electrical power generation can be controlled by controlling the amount of aluminum anode material in contact with the electrolyte solution.

As mentioned above, OH⁻ ions migrate from the cathode 220 thru the electrolyte to the anode 210, where they react with the Al atoms in the aluminum anode 210 to yield an aluminum tetrahydroxide ion Al(OH)₄ and three electrons (e-). In the electrolyte solution, Al(OH)₃ is formed and precipitates out to form an Al (OH) 3 precipitate 320 on the anode side 242. The three electrons return to the cathode 220 through the external electrical load 284, thus supplying the external load 284 with power.

### Cell Reactions

The reactions observed in the cell are:
□ The anode oxidation half-reaction is Al⁰+4OH⁻→Al(OH)₄+3e⁻−2.33V
□ In the KOH solution (hydrolysis) Al(OH)₄→Al(OH)₃+OH⁻
□ The cathode reduction half-reaction is 3H₂O+3e⁻→3OH⁻+1.5H₂+0.83V
□ The balanced equation is Al⁰+3H₂O→Al(OH)₃+1.5H₂+1.475V

### From the Nernst Equation:

□ The cell voltage from Nernst is E=−□G/nF
□ n (number of moles)=3
□ F (Faraday constant)=96,500 C/mol
□ G (change in Gibbs Free Energy)=−426 KJ/mol Al
□ Therefore, the OCV (Open Circuit Voltage) is (426×10³)/3×96500=+1.47V

The electrochemical reaction occurs by feeding a supply of aluminum (in bulk form as a rod, bar etc.) into a bath of KOH (for example). Feeding the aluminum into the KOH causes the aluminum to be electrically connected (as an anode) to the cathode. In some embodiments the cathode comprises material such as activated charcoal (Ni, for example). The aluminum will oxidize to aluminum ions, and eventually aluminum hydroxide will settle. Freed electrons will flow from the anode 210 to the cathode 220 via an electrical connection that for example may include the wires 286 and 288 external to the tank. Reduction of the incoming water occurs at the cathode, forming OH⁻ ions and hydrogen. The water is fed into the cathode side. Current flows due to the movement of electrons from the anode to the cathode through the external load and back to the anode, via the transport of the OH⁻ ions. This current results in the production of electrical power. The electrical power that is produced is equivalent to the Gibbs free energy produced by the exothermic chemical reaction via the chemical oxidation of aluminum-to-aluminum hydroxide. Thus, electrical energy is produced rather than thermal energy, as well as the equivalent stoichiometric amount of aluminum hydroxide and hydrogen.

There are a number of major differences between the Al-water cell described herein and an aluminum-air battery. First, water (instead of air) is fed to the cathode material, where it is reduced by an electrochemical reaction to OH⁻ ions and H₂. Second, the cathode is made from a material that will reduce the incoming water to OH⁻ and H₂. Third, an OH⁻ conducting membrane is used to separate the anode and cathode in the alkaline solution. Lastly, the aluminum is fed into the Al-water cell, where it is consumed.

The Al-water cell 200 described above is one embodiment of an Al-water cell included in an EGS. The following description discloses an embodiment of an EGS that controls generation of electrical power in one or more Al-water cells.

### (4) EGS: Power Management and Control

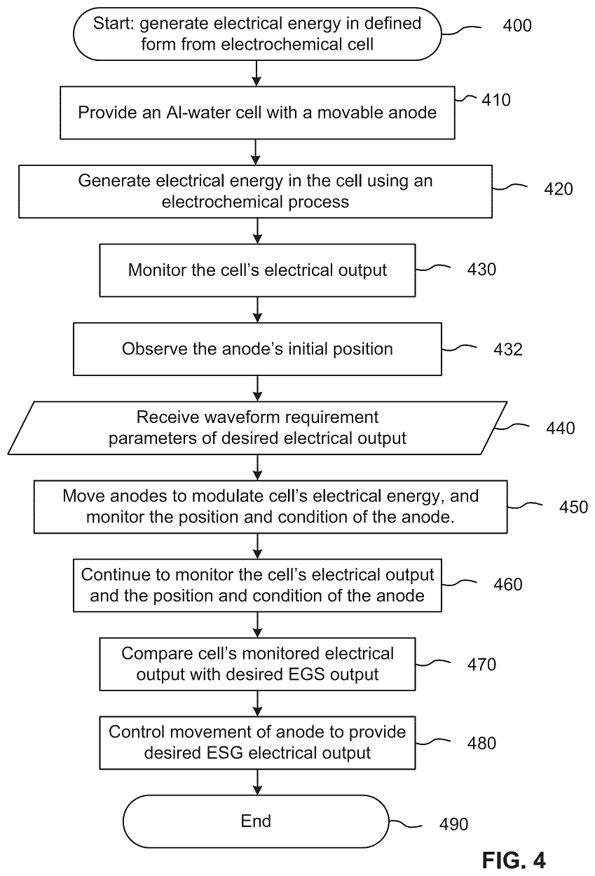

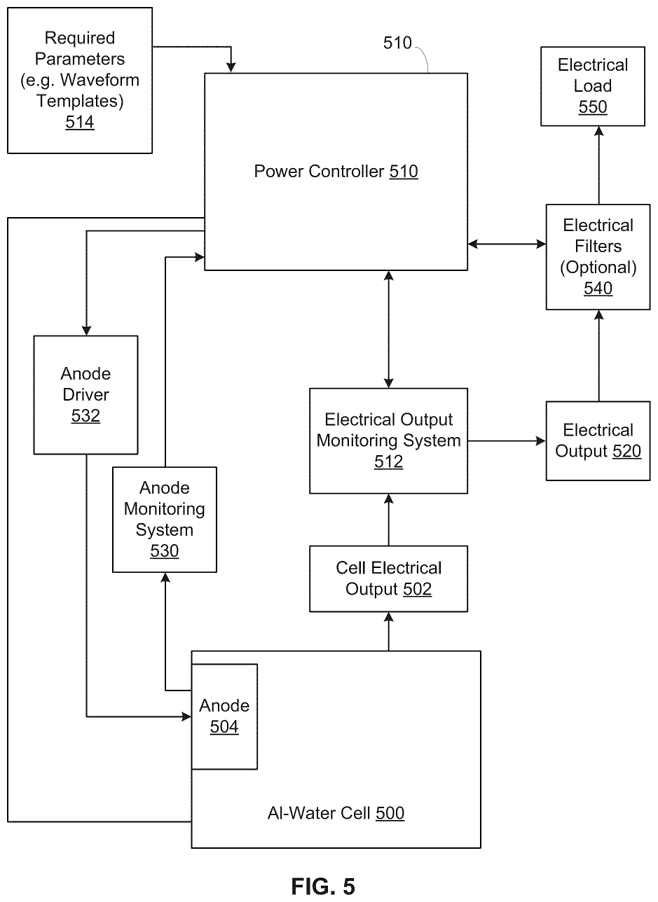

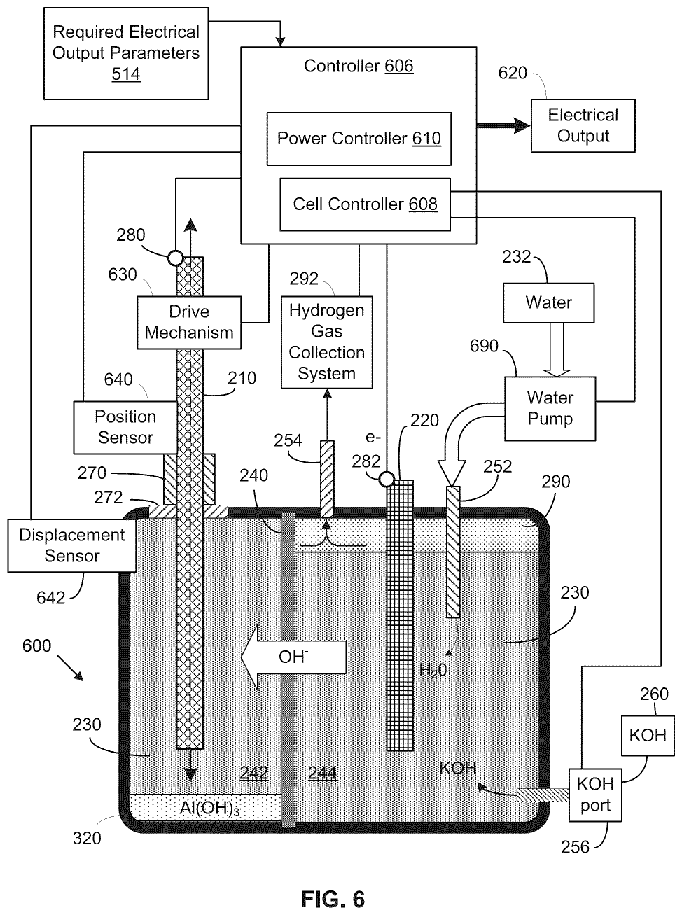

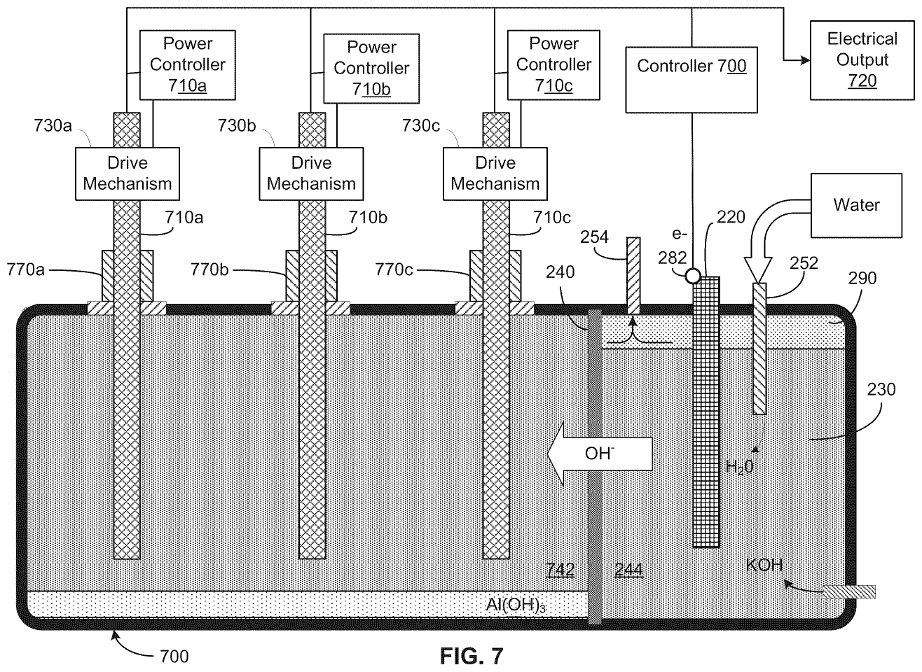

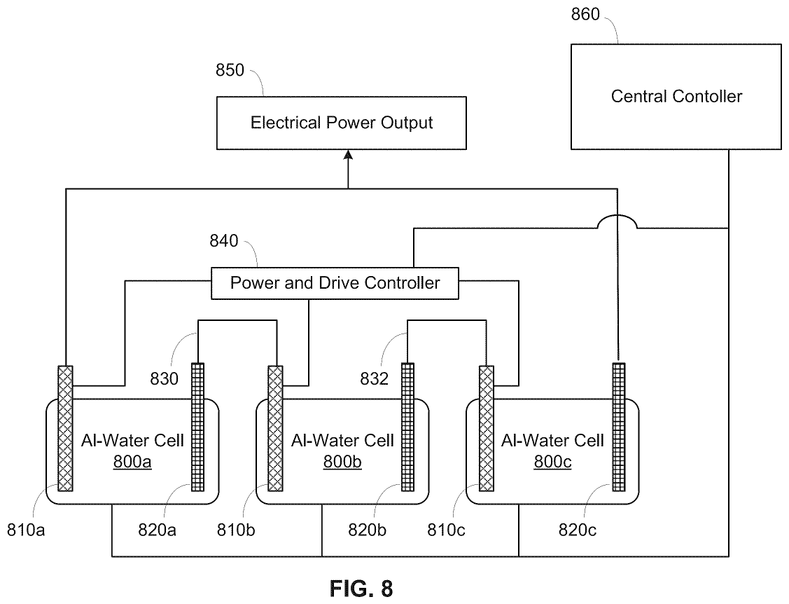

FIG. 4 is a high-level flowchart that shows steps for generating electrical energy and managing cell operations in an EGS. FIG. 5 is a block diagram of one embodiment of an EGS for generating electrical power using one or more Al-water electrochemical cells. FIG. 5 shows an EGS that includes a Power Controller 510 connected to an Al-water cell 500, which has been described with reference to FIGS. 2 and 3, for example. FIG. 6 is a schematic block diagram of one embodiment of an EGS and describes an EGS in more detail. FIGS. 7 and 8 are schematic block diagrams of alternative embodiments of an EGS.

### □ FIG. 4: Method of Power Management

FIG. 4 is a flowchart that shows steps for generating electrical energy and managing cell operations in an EGS. To generate an electrical energy waveform from an electrochemical cell (STEP 400), an Al-water cell (such as described above) with a movable anode electrode is provided (STEP 410). Electrical energy is generated in the cell using an electrochemical process (STEP 420), and the cell's output electrical energy is monitored (STEP 430).

The initial position of the movable anode (relative to the electrolyte) is observed (STEP 432); for example, the anode's depth into the electrolyte may be observed.

Waveform requirement parameters for the electrical output from the ESG are provided (STEP 440) to the control system for the ESG. The desired electrical output may be defined by a variety of parameters, such as waveform shape, frequency, voltage, current, and allowable variation of the parameters.

After receiving the desired electrical output parameters, the control system of the ESG then moves the anode to modulate the electrical output from the cell (STEP 450), and the position and condition of the anode may be monitored. Particularly, the anode may be moved to change the anode surface area in contact with the electrolyte, and the anode's position is monitored for changes in electrical output and the anode's condition is monitored as it is consumed in the electrochemical process.

The electrical output from the cell, and the position and condition of the anode continues to be monitored (STEP 460). The monitored electrical output is compared with the desired electrical output (STEP 470), and then the anode movement is modulated and controlled (STEP 480) in a pattern that provides an electrical output within the desired parameters. For example, the electrical output may supply alternating current (AC) or a direct current (DC), or it may also supply a steady or modulated voltage source. The AC may be supplied to a grid; e.g. at approximately 60 Hz, 120 Volts.

Operation then continues to provide electrical power until a circumstance arises (such as maintenance, operator command, or the anode needs replacement) to end operation (STEP 490). It should be noted that in some embodiments, replacing the anode can be done without taking the cell out of service. That is, in some embodiments, additional anode material can be feed into the cell to maintain the uninterrupted operation of the cell even as the last of the initial anode material is being consumed.

### (5) FIG. 5: EGS Block Diagram

FIG. 5 is a block diagram of one embodiment of an EGS for generating electrical power using one or more electrochemical cells. In FIG. 5, the EGS includes a Power Controller 510 that is connected to an Al-water cell 500. The Al-water cell 500 has been described for example with reference to FIGS. 2 and 3.

In the block diagram of FIG. 5, for purposes of description a number of control components may be shown separately from the Power Controller 510; in various alternative embodiments these components may be implemented within the Power Controller 510, or separate from the Power Controller as shown.

The Al-water cell 500 provides an Electrical Output 502, which is supplied to an Output Monitoring System 512 that is connected to the Power Controller 510. The Output Monitoring System 512 includes electrical components to monitor the electrical output (such as voltage current, and frequency) and supply the resultant data to the Power Controller 510.

The Power Controller 510 also receives (or has stored within it) waveform requirement parameters 514 indicative of the desired EGS output, such as waveform shape, frequency, voltage, current, and allowable variations. The parameters 514 may be stored in any suitable form, such as electronic. The parameters 514 provide suitable guidance to the Power Controller 510 as to the desired electrical output.

An anode monitoring system 530 provides relevant data regarding the position and condition of the anode 504 to the Power Controller 510. For example, the anode monitoring system 530 may monitor the depth of the anode 504 in the electrolyte and estimate the condition of the anode as it is consumed. The anode monitoring system 530 includes appropriate sensors to measure and provide data regarding the position and condition of the anode 504 in the cell's electrolyte.

Responsive to the requirement parameters 514, the monitored cell electrical output 502 (via the Monitoring System 512), and data from the anode monitoring system 530, the Power Controller 510 uses an Anode Driver 532 to controllably move the anode 504 and provide the desired electrical output 520.

The Anode Driver 532 is connected to the Power Controller 510 and the anode 504, to operably move the anode 504 and thereby control the surface area of the anode that is exposed to the cell's electrolyte. For example, the Anode Driver 532 may include a drive and release mechanism to controllably move an aluminum rod anode. After the rod has been sufficiently consumed, the release mechanism facilitates easy replacement with a new rod.

In some embodiments electrical filters 540 (passive or active) may be applied to the electrical output 520 to filter out unwanted signals. The Power Controller 510 may be connected to actively control the filters 540. The electrical output 520 via the filters 540 (if implemented) is the provided to supply power to an electrical load 550. The electrical load 550 can be anything that consumes, stores, or otherwise uses electrical energy: e.g., a motor, power grid, battery storage, or other load.

### (6) FIG. 6: Schematic Block Diagram

FIG. 6 is a schematic block diagram of an embodiment of an EGS for generating electrical power using one or more electrochemical cells. In FIG. 6, the EGS includes a Controller 606 including a Cell Controller 608 and a Power Controller 610. The Power Controller 610 is connected to an Al-water cell 600. One embodiment of the Al-water cell 600 has been described for example with reference to FIGS. 2, 3, and 5. Also, one embodiment of the Power Controller 610 has been described with reference to FIG. 5.

The Cell Controller 606 monitors and manages operation of the Al-water cell 600. Within the Controller 606, the Cell Controller 608 and the Power Controller 610 may communicate and work together cooperatively to improve and better facilitate EGS operation.

The Power Controller 610 operates to receive electrical power from the anode 210 of the cell, monitor electrical output parameters, control the electrical output power 620, and generally manages power generation to provide the desired electrical output.

The Power Controller 610 is connected to the anode terminal 280 of the anode 210, monitors the electrical output from the anode 210, and controls the cell to provide the desired electrical output 620, in accordance with the desired electrical output parameters 514. The Power Controller 610 is also connected to the cathode terminal 282 of the cathode 220 of the Al-water cell to supply the needed electrons for water reduction.

The Power Controller 610 can drive the movable anode 210 to modulate the current output from the cell. In some such embodiments, the modulation can produce a sinusoidal current that results in the output of an AC output current. In other embodiments, other modulation schemes can be implemented.

A movable anode 210 has been described (FIGS. 2 and 3) that allows the anode 210 to be driven and repositioned to change the surface area of the anode 210 in contact with the electrolyte solution. The anode 210 is preferably made of aluminum and/or alloys of aluminum in a rod configuration; however, in other embodiments other materials and other configurations may be used. One or more anode rods (or other anode shapes) may be included. The slidable sleeve 270 and flexible seal 272 are provided for each of the anode rods. The anode rod is slidably inserted into the sleeve 270 and seal 272, which allows the rod to be moved lengthwise in and out of the electrolyte, while preventing the electrolyte from leaking from the tank.

### Anode Driving Mechanism

The Power Controller 610 is connected to the drive and release mechanism 630 to drive an anode 210 up or down, and to otherwise control its position. The anode 210 may be fed into the electrolyte solution 230 on the anode side 242 with a drive and release mechanism 630. For example, the drive and release mechanism 630 may include a feeding coil that drives an aluminum alloy anode rod situated within the coil, using magnetism. In another example the drive and release mechanism 630 may include a mechanical system and motor that moves the anode rod.

In one embodiment an anode rod may be inserted through the drive and release mechanism 630 (e.g., feeding coil). Later, after or during operation, whatever portion of the rod is not consumed can be replaced by removing the spent anode rod through the release mechanism.

The Power Controller 610 is connected to receive information from anode sensors such as a position sensor 640 and a displacement sensor 642. The Power Controller 610 uses this sensed information to controllably modulate the anode and estimate the condition of the anode.

Responsive to the sensed anode information, the electrical output from the Al-water cell 600, and the desired waveform, the Power Controller 610 controls the drive mechanism 630 to drive the rod to provide the desired power, and it may modulate the rod(s) up and down to provide the desired waveform. In other words, by controlling the position of the anode in the electrolyte (e.g. driving the anode up and down between appropriate depths), the electrical output current can be modulated, and thereby power generation can be controlled.

### Sensors

Suitable sensors are used to determine the position of the rod and estimate material consumption during operation. In FIG. 6, a position sensor 640 is provided to determine the position of the anode rod using any appropriate positioning technology. A displacement sensor 642 is provides to monitor the amount of anode material that has been consumed during operation.

These sensors are connected to the Power Controller 610 to provide feedback that allows the system to move and control the position of the anode rod to provide the desired electrical output.

Generally, the sensed parameters are indicative of the position and condition of the anode in the solution, and include information related to the surface area of the anode exposed to the electrolyte, and therefore available for reaction. This information may include the depth of an anode rod in the solution, and the anode rod's electrolyte solution displacement.

### Cell Controller

FIG. 6 shows the Cell Controller 608 connected to receive cell operational data inputs relating to operation and condition of the Al-water cell 600, which allows it to monitor and control operation of the cell. Particularly, the Cell Controller 608 is connected to the Hydrogen Gas Collection System 292 to provide sensed information regarding the amount of hydrogen being generated. The Cell Controller 608 may be connected to one or more electrolyte concentration sensors (not shown) situated on or around the cell tank. Other inputs relating to operation and condition of the cell 600 may also be provided to the Cell Controller 608.

In response, the Cell Controller 608 may utilize the KOH port 256 to adjust the electrolyte concentration to the appropriate amount. The Cell Controller 608 can also control a water pump 690 to provide an appropriate supply of water 232 for reaction with the water-reducing cathode 220.

### Alternative Embodiments

Following, alternative embodiments will be described in which multiple cells are electrically connected in series and/or in parallel and controlled together. A multiple cell configuration can provide more power and/or higher voltages. Many more alternative embodiments are possible.

### (7) Multiple Rods, Single Cell Embodiment

FIG. 7 is a diagram of an alternative embodiment of an EGS that has multiple anode rods 710 situated in a single cell 700. The anode side 742 includes a plurality of anodes rods 710a, 710b, 710c. In the illustrated embodiment three anodes 710 are shown, in other embodiments additional anodes. Each of the anode rods 710 is similar to those anodes 210 described with reference to FIGS. 2 and 3. Each of the anode rods 710 is slidably inserted into the sleeve and seal 770, which allows the anodes 710 to be moved lengthwise in and out of the electrolyte, while preventing the electrolyte from leaking from the tank. The movability of each anode 710 allows the anodes to be repositioned to change the surface area of the anode 210 in contact with the electrolyte solution.

The cathode side 244 has a similar configuration to that described with reference to FIG. 2.

The anode rods are electrically connected to provide a single output. Preferably, the electrical connection type is a parallel connection between each of the anode rods in the cell.

The Power Controller 710 is connected to each rod and monitors each rod using sensors such as position sensors and displacement sensors, such as shown in FIG. 6. A master controller 700 is connected to each of the Power Controllers 710 and may monitor and control operation of all of anodes to provide the desired output power 720.

In many embodiments each rod may have its own position sensors and drivers, and be controlled independently. In other embodiments one or more rods may be controlled together. This configuration, with multiple rods connected in parallel, can advantageously provide more power than a single anode rod. Also, the multiple rod configuration may be useful to control the output power more accurately.

### (8) Multi-Cell Embodiment

FIG. 8 shows a multiple cell embodiment, in which a plurality of Al-water cells 800, including a first cell 800a, a second cell 800b, and a third cell 800c are connected in series, which provides more voltage. Each cell 800 produces a voltage theoretically around 1.47 volts, (although in practice the voltage may be in the range of 1-2 volts). When the cells 800 are connected in series, the voltage of each cell 800 can be summed to provide a greater voltage; e.g., three cells connected in series can provide 3×1.47=4.41 volts. In other words, the effective voltage can be increased by incorporating multiple cells 800 in series.

Each Al-water cell 800 may be configured as described above for individual cells such as the cell 200 shown in FIGS. 2 and 3. Each cell 800 has a corresponding anode 810 and cathode 820. To connect in series, the first cathode 820a is electrically connected at 830 to the second anode 810b, and the second cathode 820b is electrically connected at 832 to the third anode 810c.

To provide the power output 850; the first anode 810a is connected to provide the anode connection, and the third cathode 820c is connected to provide the cathode connection.

The anode of each cell 800 is connected to a Power and Drive Controller 840 that operates to monitor and control each anode to provide the desired electrical output as described elsewhere in this application. Each cell may have its own Power Control section in the Power and Drive Controller 840, and each cell may operate independently; i.e., each anode 810 may be monitored and controlled separately. Alternatively, the Power and Drive Controller 840 may be used to monitor and control all cells 800, and the combined power output. Generally, there will be a Central Power Controller 860 connected to the cells 800 and the Power and Drive Controller 840, and other components, that monitors the entire system and each individual cell, processes the data, and responsive thereto provides information and instructions to control each of the individual cells.

### (9) Conclusion

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, and/or parallel fashion.

It is to be understood that the foregoing description is intended to illustrate and not to limit the scope of the invention, which is defined by the scope of the following claims, and that other embodiments are within the scope of the claims. In particular, the scope of the invention includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

What is claimed is:

1. An Al-water cell that produces electrical energy, comprising:
a tank;
an aqueous electrolyte solution in the tank;
a movable anode at least partially submersed in the electrolyte solution, wherein an immersed surface area is defined by the surface of the anode exposed to the electrolyte, the anode comprising an aluminum material;
a water-reducing cathode submersed in the electrolyte solution;
a membrane situated between the anode and the cathode, the membrane allowing passage of hydroxide ions from the cathode to the anode;
an electrical connection between the anode and cathode; and
a controllable drive mechanism connected to drive the anode within the electrolyte, the drive mechanism for controllably moving the anode to vary the immersed surface area of the anode in the electrolyte solution.

2. The Al-water cell of claim 1 further comprising a slidable seal situated between the tank and the anode.

3. The Al-water cell of claim 2 wherein the tank defines an anode opening, the anode has a rod configuration, and the slidable seal is situated between the rod and the tank's anode opening to substantially prevent electrolyte leakage from the tank.

4. The Al-water cell of claim 1 wherein the tank defines an anode side and a cathode side separated by the membrane, and the cathode side includes:
a gas outlet for hydrogen gas; and
a water inlet for supplying water.

5. The Al-water cell of claim 1 wherein the anode comprises an aluminum alloy material.

6. The Al-water cell of claim 1 wherein the electrolyte substantially comprises KOH.

7. The Al-water cell of claim 1 wherein the cathode comprises an extruded graphite rod.

8. The Al-water cell of claim 1 wherein the membrane is at least one of a solid oxide membrane and a proton conducting membrane.

9. An Electric Generation System (EGS) that uses aluminum as a fuel, comprising:
an Al-water cell that generates an electrical output, including a tank and an aqueous electrolyte solution in the tank;
a movable anode that includes at least one aluminum rod movably inserted in the electrolyte solution thereby controlling surface area of the anode exposed to the electrolyte solution;
a cathode inserted in the electrolyte solution that reduces water to hydrogen gas and hydroxide ions;
a membrane situated between the anode and cathode that allows passage of hydroxide ions;
an electrolyte for transporting the ions from the cathode to the anode; and
an electrical connection between the anode and cathode;
an electrical monitoring system that monitors the electrical output from the cell, the monitoring system connected to the electrical connection; and
a power controller that controllably moves the anode to control electrolyte exposure and provide a desired electrical output from the cell, responsive to the anode position and monitored electrical output.

10. The EGS of claim 9 further comprising:
an anode monitoring system connected to the power controller that monitors the position of the anode in the Al-water cell; and
an anode driver connected to the power controller and the anode, to move the anode within the electrolyte, the anode driver connected to the power controller to modulate the electrical output from the cell.

11. The EGS of claim 10 wherein the anode monitoring system includes a position sensor that measures the position of the anode, and a displacement sensor that measures the displacement of the anode.

12. The EGS of claim 9 wherein the power controller controls the Al-water cell to generate an electrical output that includes alternating current.

13. The EGS of claim 12 wherein the alternating current is approximately 60 Hz, 120 Volts.

14. The EGS of claim 9 wherein the power controller receives waveform requirement parameters and modulates the anode responsive to the waveform requirement.

15. The EGS of claim 9 wherein the anode comprises an aluminum alloy, and the cathode comprise extruded graphite.

16. The EGS of claim 15 further comprising a cell controller connected to the power controller, the cell controller monitoring cell operations, supplying water, and collecting hydrogen gas.

17. A method of generating electrical energy from an Al-water cell, comprising:
providing an Al-water cell that has a movable anode;
generating electrical energy in the cell;
monitoring the cell's electrical output;
observing the anode's initial position;
accessing waveform requirement parameters indicative of the desired electrical output; and
driving the anode to modulate the cell's electrical energy responsive to the waveform requirement parameters to provide the desired electrical output.

18. The method of claim 17 further comprising monitoring the anode to provide data indicative of the position of the anode in the electrolyte and modulating the anode responsive to the position data and the waveform requirement parameters.

19. The method of claim 17 further comprising comparing the cell's generated electrical energy with the waveform requirement parameters, and modulating the anode responsive to said comparison.

20. The method of claim 17 further comprising monitoring the condition of the anode.
